(19) United States
(12) Patent Application Publication
(10) Pub. No.: US 2010/0177654 A1
(43) Pub. Date: Jul. 15, 2010

(54) OPERATING CARRIER SELECTION FOR HOME NETWORK

(75) Inventors: Gilles Charbit, Hampshire (GB); Tao Chen, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/667,089

(22) PCT Filed: Jun. 25, 2008
(86) PCT No.: PCT/IB08/01673

§ 371 Date: Dec. 29, 2009

(30) Foreign Application Priority Data
Jun. 29, 2007 (US) 60947224

(51) Int. Cl. H04L 12/26

(52) U.S. Cl. 370/252

(57) ABSTRACT

Various embodiments are disclosed relating to carrier selection for a home network. In an example network, a method may include using a first carrier frequency to transmit in a downlink direction to a mobile node in a home wireless network, and receiving, from the mobile node, a signal strength measurement for each of a plurality of carrier frequencies. The method may further include receiving, from the mobile node, an error report for the first carrier frequency, and determining that a link quality for the first carrier frequency is below a threshold based on the error report. The method may further include selecting a second carrier frequency from the plurality of carrier frequencies based on the determining and based on the signal strength measurement of the second carrier frequency, and changing, based on the selecting, from the first carrier frequency to the second carrier frequency to transmit data in a downlink direction to the mobile node.

### PRIORITY CLAIM

This application claims the benefit of priority based on U.S. Provisional Application No. 60/947,224, filed on Jun. 29, 2007, entitled, “Operating Carrier Selection for Home Network,” the disclosure of which is hereby incorporated by reference.

### TECHNICAL FIELD

This description relates to wireless networks and carrier selection.

### BACKGROUND

Information transfer over wireless networks often uses wide bandwidths to transfer large amounts of data. With multiple nodes located in proximity to each other and communicating in overlapping bandwidths, interference from other nodes may cause a given node to suffer from an error rate which exceeds an acceptable threshold. One technique for reducing interference between nodes is to utilize smaller networks which require less transmitting power for the nodes within the smaller networks to communicate. Another technique is for the nodes to change to a different carrier frequency which has less interference.

### SUMMARY

According to one general aspect, a method may comprise using a first carrier frequency to transmit in a downlink direction to a mobile node in a home wireless network, and receiving, from the mobile node, a signal strength measurement for each of a plurality of Downlink (DL) carrier frequencies. The method may further include receiving, from the mobile node, an error report for the first carrier frequency, and determining that a link quality for the first carrier frequency is below a threshold based on the error report. The method may further include selecting a second carrier frequency from the plurality of carrier frequencies based on the determining and based on the signal strength measurement of the second carrier frequency, and changing, based on the selecting, from the first carrier frequency to the second carrier frequency to transmit data in a downlink direction to the mobile node. The carrier frequencies may be CDMA (code division multiple access) carrier frequencies, for example, or wideband CDMA (W-CDMA) carrier frequencies, or other type of carrier frequencies.

According to another general aspect, a method may comprise monitoring interference from an overlay wireless network and/or neighboring home wireless network for each of a plurality of DL carrier frequencies, compiling a list including at least one of the plurality of carrier frequencies, selecting a transmission carrier frequency from the list having a next lowest level of interference, and transmitting data to a mobile node via the selected transmission frequency.

According to another general aspect, a method may include receiving, from a mobile node in a home wireless network, a signal strength measurement for each of a plurality carrier frequencies during a transmission gap interval. The method may further include selecting a carrier frequency based on the signal strength measurement, and communicating with the mobile node along the selected carrier frequency.

According to another general aspect, a method may include receiving, from a mobile node in a home wireless network, a signal strength measurement for each of a plurality of carrier frequencies. The method may further include selecting a carrier frequency which has a lower signal strength measurement than the other carrier frequencies in the plurality of carrier frequencies, and communicating with the mobile node along the selected carrier frequency. Hence, the selected carrier may have the lowest level of interference from an overlay wireless network and neighboring home wireless network.

According to another general aspect, an apparatus may comprise a controller. The apparatus may be configured to use a first DL carrier frequency to transmit in a downlink direction to a mobile node in a home wireless network, receive, from the mobile node, a signal strength measurement for each of a plurality of DL carrier frequencies, receive, from the mobile node, an error report for the first carrier frequency, determine that a link quality for the first DL carrier frequency is below a threshold based on the error report, select a second DL carrier frequency from the plurality of DL carrier frequencies based on the determined link quality and based on the signal strength measurement of the second DL carrier frequency, and change, based on the selection, from the first DL carrier frequency to the second DL carrier frequency to transmit data in a downlink direction to the mobile node.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram showing an overlay wireless network and two home wireless networks according to an example embodiment.

FIG. 2 is a flowchart showing three phases associated with a home base station according to an example embodiment.

FIG. 3 is a flowchart showing an auto-setup method corresponding to a base station auto-setup phase shown in FIG. 2 according to an example embodiment.

FIG. 4 is a flowchart showing a new mobile node call method corresponding to a new mobile node call phase shown in FIG. 2 according to an example embodiment.

FIG. 5 is a flowchart showing an ongoing mobile node call method corresponding to an ongoing mobile node call phase shown in FIG. 2 according to an example embodiment.

FIG. 6 is a flowchart showing a method according to an example embodiment.

FIG. 7 is a flowchart showing another method according to another example embodiment.

FIG. 8 is a flowchart showing another method according to another example embodiment.

FIG. 9 is a block diagram of a wireless node according to an example embodiment.

### DETAILED DESCRIPTION

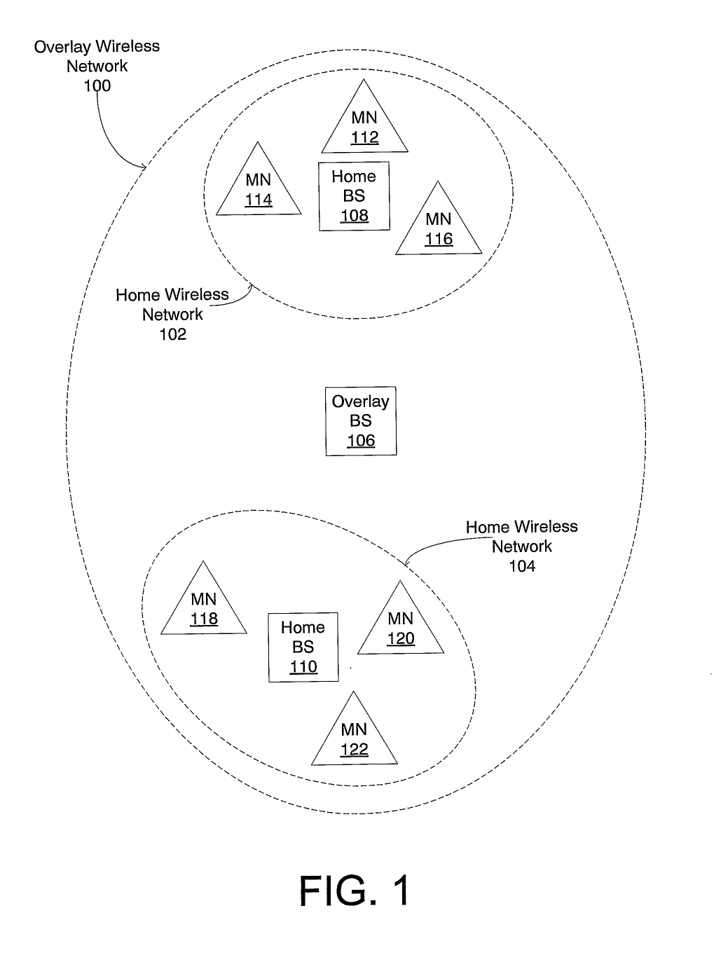

FIG. 1 is a block diagram showing an overlay wireless network 100 and two home wireless networks 102, 104. The overlay wireless network 100 may include, for example, a cell such as a macrocell or a microcell within a cellular telephone network, wireless LAN (wireless local area network), WiMAX or other wireless network or cell. These are a few example wireless technologies, but overlay wireless network 100 may be based on any type of wireless technology or standard. The overlay wireless network 100 may, for example, have a radius anywhere between, e.g., fifty or one hundred meters and twenty kilometers. However, this radius or range is an example, and overlay wireless networks of other sizes or ranges may be used.

The overlay wireless network 100 may be served by an overlay base station 106, according to an example embodiment. The overlay base station 106, which may include a cellular base station (BS), node B, access point (AP), or other infrastructure node (as examples), may include a transmitter, a receiver, and a control unit. The overlay wireless network 100 may or may not utilize sectoring, by which the overlay base station 106 communicates with other nodes by transmitting to and receiving from only part of the overlay wireless network 100, such as by dividing the overlay network 100 into 120° or 60° degree sectors, rather than omnidirectionally. The overlay base station 106 may be in communication with a radio Network controller (RNC) or mobile switching center (not shown) which may control mobile node handovers between different overlay cells or overlay networks and provides access to the public switched telephone network or other wired network, according to an example embodiment.

The home wireless networks 102, 104 may also be based on any wireless technology or standard, and may typically be smaller, or may have a range or radius that is smaller than the overlay wireless network 100. Home wireless networks 102, 104 may, for example, have sufficient range to cover inside a small building, such as a home or coffee shop, etc. Thus, the term or phrase “home network” is not limited to a home, but rather may be a network that is of relatively small range or radius (e.g., such as for a home, small building or office, coffee shop, and the like), as compared to the overlay wireless network 100 (which may typically have a larger and overlapping range). While two home wireless networks 102, 104 are shown in FIG. 1, any number or plurality of home wireless networks 102, 104 may be included according to various embodiments. Multiple overlay wireless networks may also overlap any home wireless network.

The home wireless networks 102, 104 may each include an area with a radius of ten, or a few tens, of meters, such as a radius of less than one hundred meters, for example. However, the exact radius or range for home wireless networks 102, 104 may vary, as these are merely some examples. The home wireless networks 102, 104 may each have an area of coverage which is included in the area covered by the overlay wireless network 100; the overlay wireless network 100 may typically have an area of coverage which is greater than and overlaps the area of coverage of the home wireless networks 102, 104, according to an example embodiment.

The home wireless network 102, 104 may be served by home base stations 108, 110, respectively, according to an example embodiment. The home base stations 108, 110 may transmit data to, and receive data from, one or more mobile nodes 112, 114, 116, 118, 120, 122 within their respective home wireless networks 102, 104. The mobile nodes 112, 114, 116, 118, 120, 122 may include cellular phones, personal digital assistants (PDAs), WLAN or WiMAX devices, wireless smart phones, or wireless laptop computers, or other wireless devices, according to example embodiments. For simplicity, further references shall be made to the home wireless network 102, home base station 108, and mobile nodes 112, 114, 116. The mobile nodes within home wireless networks 102 and 104 may be, for example, wireless devices that use code division multiple access (CDMA) technology, such as Wideband CDMA (WCDMA).

The home base station 108 may communicate with each of the one or more mobile nodes 112, 114, 116 within its home wireless network 102. In an example embodiment, the home base station 108 may utilize frequency division duplexing (FDD), in which the home base station transmits data to the mobile nodes 112, 114, 116 along a first carrier frequency, and receives data from the mobile nodes 112, 114, 116 along a second carrier frequency. “Carrier frequency” may refer to a band of frequencies, such as 824 MHz to 829 MHz or 1.800 GHz to 1.805 GHz, as non-limiting examples which allocate five MHz of bandwidth to each carrier frequency.

The home base station 108 may transmit to all of the mobile nodes 112, 114, 116 using the same carrier frequency, or may transmit to each of the one or more mobile nodes 112, 114, 116 using a different carrier frequency; similarly, the home base station 108 may receive data from all of the mobile nodes 112, 114, 116 using the same carrier frequency or using different carrier frequencies. A one-to-one correspondence may or may not exist between the transmission or downlink carrier frequencies and the reception or uplink carrier frequencies.

The home base station 108 may use as an example embodiment a code division multiple access (CDMA) system to communicate with different wireless nodes 112, 114, 116 using the same carrier frequency, and by assigning a different code to each mobile node or user. The use of CDMA or W-CDMA carrier frequencies is merely one example embodiment and the disclosure is not limited thereto. Any type of carrier frequencies or multiple access scheme may be used, such as FDMA (frequency division multiple access), TDMA (time division multiple access) or other technique.

One carrier frequency may be used for uplink communications from mobile nodes to the home base station, and a second carrier frequency may be used for downlink communications from the home base station to the mobile nodes in the home wireless network. Different CDMA codes may be assigned to each mobile node. In addition, one or more (or even all) of the carrier frequencies used by home wireless networks 102, 104 may also be used or shared by overlay wireless network 100. Therefore, transmissions from overlay BS 106 (or other nodes in overlay wireless network 100) may create interference within home wireless networks 102 and 104.

The CDMA system may provide a “soft” capacity limit, which has no absolute limit to the number of users of a given carrier frequency; as the number of users of the carrier frequency increases, a noise floor of the carrier frequency may increase in a linear manner. A node utilizing a carrier frequency with a high number of users may continue to use the carrier frequency and accept the error rate associated with the noise floor caused by the high number of users, or may search for a carrier frequency with a lower noise floor, according to an example embodiment.

According to an example embodiment, the home base station 108 may utilize wideband code division multiple access (W-CDMA), which utilizes a CDMA system with a wide bandwidth allocated to each carrier frequency, such a five MHz, for example. A W-CDMA system may have only a few available frequency carriers, due to the wide bandwidth of each frequency carrier.

In an example embodiment, a home wireless network may share one or more carrier frequencies with other networks or sources of interference, such as an overlay wireless network. It may be desirable to select a carrier frequency for use by the home wireless network which provides a relatively low level of interference as measured at the home wireless network. In an example embodiment, an amount or level of interference from carriers from the overlay wireless network or other sources (e.g., other home wireless networks) may be measured by a carrier signal strength measurement. A lower carrier signal strength measurement may typically correspond to a lower level of interference from the carrier. Thus, for example, a carrier frequency may be selected to provide a relatively low interference level (e.g., selecting a carrier frequency that has a relatively low or a next lowest, or even the lowest, measured signal strength from the list of carrier frequencies).

The frequency channel(s) along which the home base station 108 communicates with the mobile nodes 112, 114, 116 may suffer from interference from, for example, transmission from devices outside the home wireless network 108, such as from the overlay base station 106 or other networks, such as from neighboring home wireless networks (e.g., home wireless network 104). The frequency channel(s) may also suffer from noise caused by other sources. The combination of interference and noise may make communication along a given frequency channel (or carrier frequency) difficult and/or impractical, or may cause increased error rates and/or require lower data transmission rates.

Therefore, it may be desirable for the home base station 108 to select a carrier frequency for downlink transmission to mobile nodes (or for uplink transmission) that has less traffic and interference. In an example embodiment, this may be challenging in a CDMA based network, although the disclosure is not limited thereto. In a CDMA or W-CDMA system, selecting a carrier frequency based only on received signal strength may not always allow selection of a best or even an acceptable carrier frequency. This is because, for CDMA, selecting a carrier frequency based on a received signal strength on a CDMA pilot channel (a different code than data channels) does not indicate the amount of traffic or users sharing the carrier frequency. The pilot channel and the various users or nodes in a CDMA network may each use different CDMA codes to transmit data over that carrier frequency. Thus, analyzing received signal strength of a CDMA pilot channel may not typically provide an indication of the amount of traffic, interference or number of users on a particular carrier frequency for CDMA based networks.

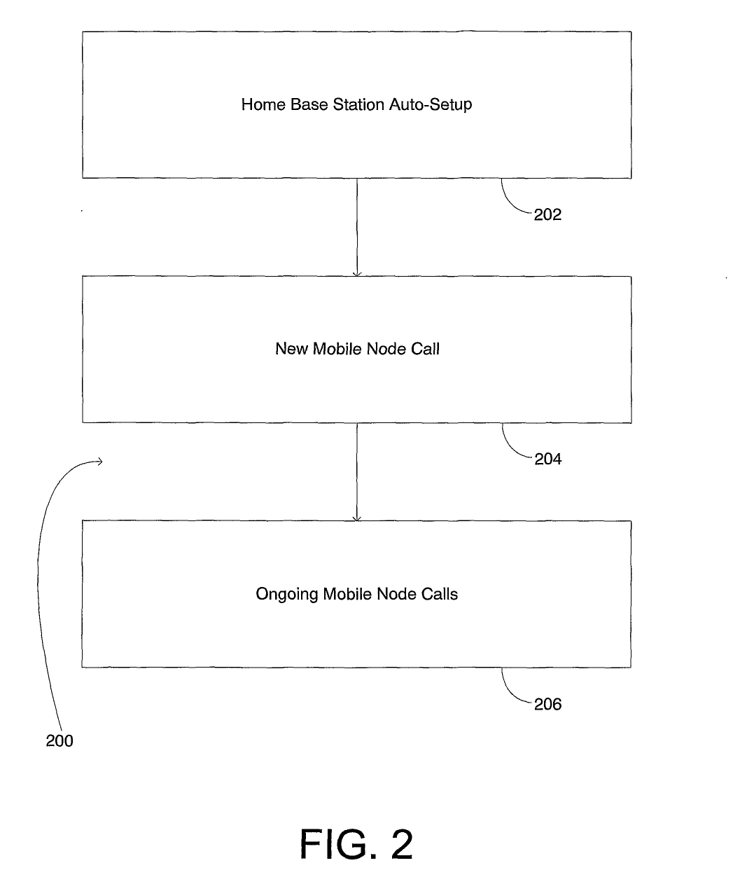

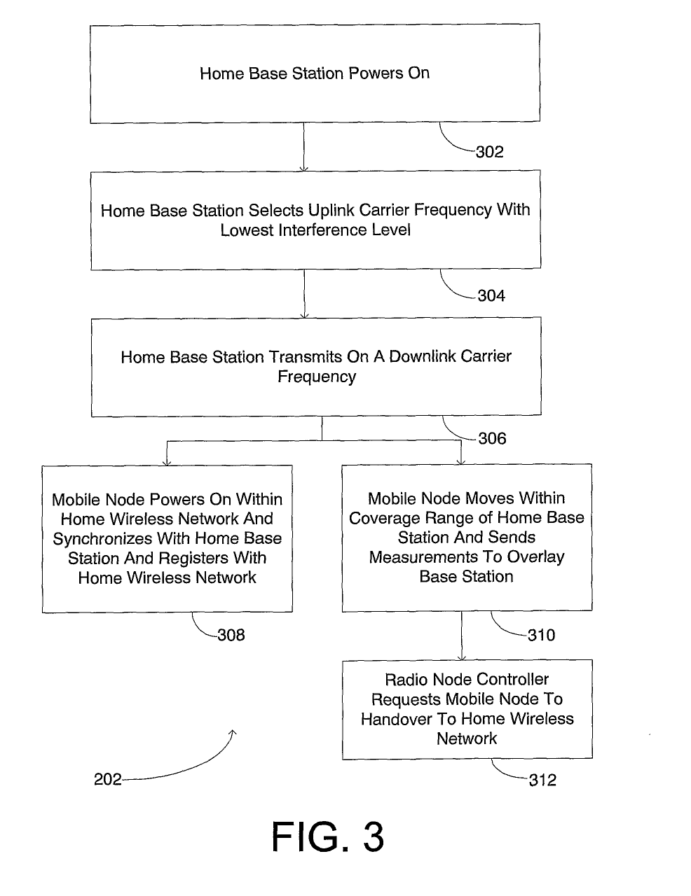

FIG. 2 is a flowchart showing three phases associated with the home base station 108 according to an example embodiment. The three phases may include a home base station auto-setup phase (202), a new mobile node call phase (204), and an ongoing mobile node call phase (206). The home base station auto-setup phase (202) may begin when the home base station 108 powers on, according to an example embodiment. The new mobile node call phase (204) may begin after a mobile node 112 has registered with a home network through the home base station 108. The ongoing mobile node call phase (206) may begin after the home base station 108 and mobile node 112 have established communication, and may continue as long as the home base station 108 and mobile node 112 remain in communication. These phases are described in detail with respect to FIGS. 3-5.

FIG. 3 is a flowchart showing an auto-setup method 202 corresponding to the base station auto-setup phase (202) shown in FIG. 2. In the example shown in FIG. 3, the home base station 108 powers on (302). The home base station 108 may select an uplink carrier frequency with the lowest interference level (304). The home base station 108 may, for example, measure signal strengths from mobile nodes at a plurality of possible uplink carrier frequencies on the overlay network or the neighboring home networks, and select the carrier frequency with the lowest measured signal strength as the uplink carrier frequency. Hence, the selected UL carrier is likely to have the lowest level of interference.

After selecting the uplink carrier frequency (304), the home base station 108 may transmit on a downlink carrier frequency. The downlink carrier frequency may be based on the selected uplink carrier frequency. For example, there may be a one-to-one correspondence between the uplink carrier frequency and the downlink carrier frequency, such as a predetermined difference between the uplink carrier frequency and the downlink carrier frequency.

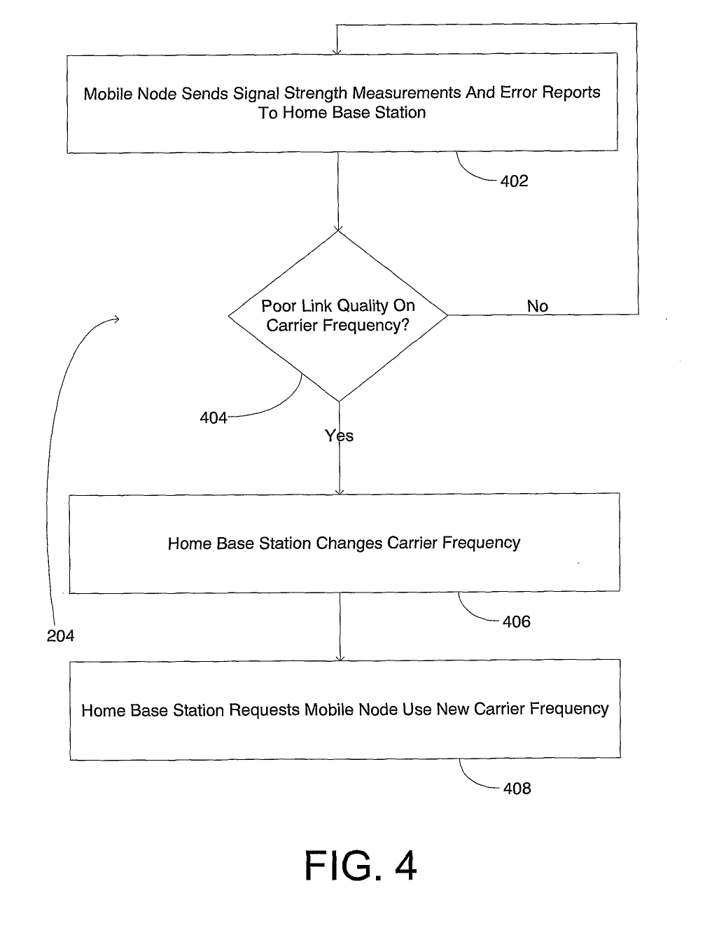

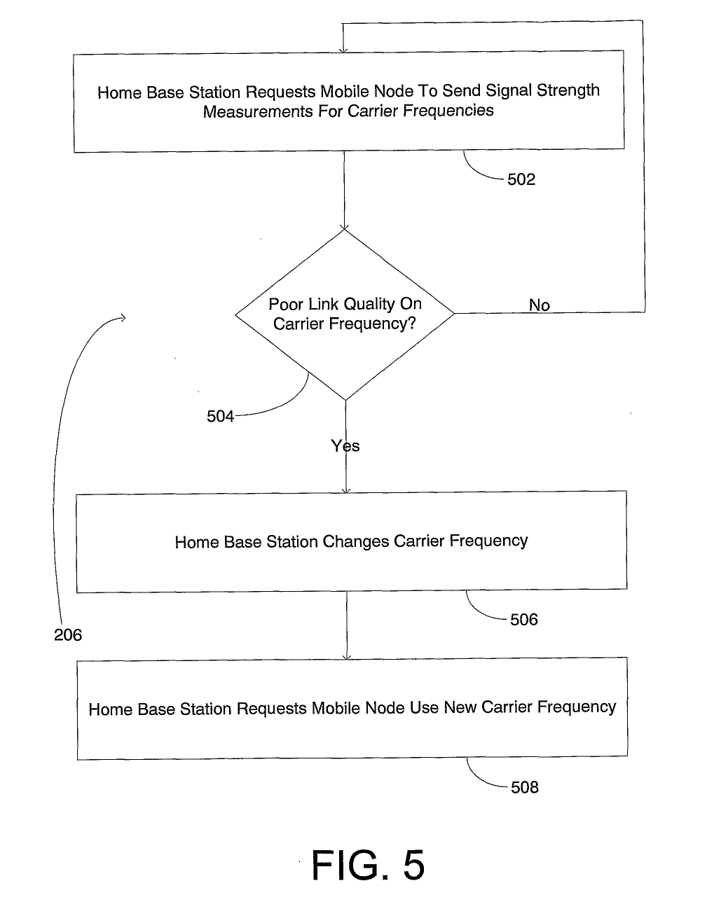

A mobile node 112 may receive initial downlink data transmissions from the home base station 108 by either powering on within the home wireless network 102 or by moving into the home wireless network 102 by moving within the coverage range of the home base station 108. If the mobile node 112 powers on within the home wireless network 102, the mobile node 112 may synchronize with the home base station 108 and register with the home wireless network 102 (308), according to an example embodiment. The mobile node 112 may, for example, receive messages and/or data from the home base station 108 via the downlink frequency which was selected by the home base station 108 as described in paragraph [0035]. The mobile node 112 may register with the home wireless network 102 by transmitting data and/or messages to the home base station 108 via the selected uplink frequency. The uplink frequency and/or downlink frequency may subsequently be changed, as described with reference to FIGS. 4 and 5.

If a mobile node 112 which has been powered on outside the home wireless network 102 moves within the coverage range of the home base station 108, the mobile node 112 may send measurements to the overlay base station 106 (310). The mobile node 112 may, for example, measure signal strengths of data received from the home base station 108 and/or the overlay base station 106, and forward these measurements to the overlay base station 106. The overlay base station 106 may forward these measurements to the radio network controller, according to an example embodiment.

The radio network controller may decide, based on these measurements, that the wireless node 112 should handover from the overlay wireless network 100 to the home wireless network 102. Accordingly, the radio network controller may request the mobile node 112 to handover to the home wireless network 102 (312). After handing over to the home wireless network 102, the wireless (mobile) node 112 and/or home base station 108 may determine whether to continue to use the carrier frequencies selected by the home base station 108, or to change to a new carrier frequency, as discussed with reference to FIGS. 4 and 5. Alternatively, the home base station 108 may determine (or make the determination) whether the mobile node 112 should handover from wireless overlay network 100 to home wireless network 102.

FIG. 4 is a flowchart showing a new mobile node call method 204 corresponding to the new mobile node call phase (204) shown in FIG. 2 according to an example embodiment. According to this method, the home base station 108 may have been transmitting to the mobile node 112 in the home wireless network 102 in a downlink direction using the first carrier frequency, such as a first CDMA carrier frequency. The first carrier frequency may have been selected as described with reference to FIG. 3, for example.

The mobile node 112 may receive the transmissions, such as data transmissions, from the home base station 108 along the first carrier frequency. The mobile node 112 may generate and send one or more error reports to the home base station 108. The error reports may include acknowledgments (ACKs) and/or negative acknowledgments (NACKs), and/or block error reports, according to an example embodiment. According to another example embodiment, an error report may indicate an error rate or a number or rate of NACKs detected by the mobile node 112 for the first carrier frequency. According to another example embodiment, the error report(s) may include a block error report.

The mobile node 112 may also measure signal strengths of the first carrier frequency and/or other available carrier frequencies (which may be CDMA carrier frequencies and/or W-CDMA carrier frequencies). The mobile node 112 may, for example, measure the signal strengths of pilot tones for each of the carrier frequencies. The first carrier frequency and other available carrier frequencies may be shared between the home wireless network 102 and the overlay wireless network 100, according to an example embodiment. The mobile node 112 may measure the signal strength of the first carrier frequency while receiving data from the home base station 108.

The mobile node 112 (and other mobile nodes 114, 116) may measure the signal strength of the other available carrier frequencies during an idle data transmission period (or pause in data transmissions), such as a data transmission gap interval during compressed mode in W-CDMA, according to an example embodiment. The data transmission gap interval may be a time during which the home base station 108 ceases transmission in the first carrier frequency, which may allow the mobile node 112 (and other mobile nodes 114, 116) to measure the signal strength of other available carrier frequencies. Or, the data transmission gap interval may be a time during which the home base station 108 ceases transmission in the first carrier frequency for other reasons, such as to time division multiplex data transmissions to other mobile nodes 114, 116. The mobile node 112 (and other mobile nodes 114, 116) may measure the signal strength of one carrier frequency during each data transmission gap interval, or may measure the signal strengths of a plurality of carrier frequencies during a single data transmission gap interval, such as by dividing the data transmission gap interval into a plurality of time slots and measuring the signal strength of one carrier frequency during each time slot, according to example embodiments.

The mobile node 112 may send the signal strength measurements for each of the plurality of carrier frequencies (which may be CDMA or W-CDMA carrier frequencies), and/or the error report for the first (downlink) carrier frequency, to the home base station 108 (402). Likewise, where there are multiple nodes in the home network, each of nodes 112, 114 and 116 may each send their signal strength measurements for each of the plurality of carriers to the home base station 108. The home base station 108 may receive the signal strength measurements and/or the error report during or after the transmission gap interval. According to an example embodiment, the home base station 108 may generate or compile a ranked list including one or more of the plurality of carrier frequencies. The ranked list may include all of the plurality of carrier frequencies, or may include only those carrier frequencies with signal strengths below a predetermined level. The list may be based upon the signal strength measurements received by one or more nodes, e.g., from nodes 112, 114 and/or 116. The ranked list may be based on, for example, average signal strengths for each carrier, e.g., in the case of multiple nodes reporting signal strengths.

In some cases, the received signal strength measurements may provide some type of indication of interference on a carrier frequency, for example. The carrier frequencies in the ranked list may be ranked according to the signal strength measurements in either ascending or descending order, and/or may include the signal strength measurements. The ranked list may be continuously updated as new signal strength measurements are received to remain current with time-varying interference levels. By receiving the signal strength measurements, the home base station 108 may monitor interference from both the overlay wireless network 100 or overlay cell and one or more home wireless networks 102, 104 or home cells for each of the plurality of carrier frequencies.

The home base station 108 may determine whether there is a poor link quality on the carrier frequency (404), such as by determining that the link quality for the first carrier frequency is below a threshold based on the error report, according to an example embodiment. The threshold may, for example, be based on a minimum quality of service that is deemed to be acceptable for a user of the mobile node 112, e.g., if the error report indicates that the block error rate exceeds a threshold, for example. If the home base station 108 determines that the link quality is not poor or is not below the threshold, then the home base station may continue to receive signal strength measurements and/or error reports from the mobile node 112. If the home base station 108 determines that the link quality is poor or is below the threshold (e.g., block error rate for first carrier frequency is greater than a threshold), then the home base station 108 may change the carrier frequency (406).

The home base station 108 may change the carrier frequency by, for example, selecting a second (downlink) carrier frequency from the plurality of carrier frequencies, such as the carrier frequencies on the ranked list, based on the signal strength measurements. The carrier frequencies may be, for example, CDMA or W-CDMA carrier frequencies, according to example embodiments, although the disclosure is not limited thereto. The home base station 108 may, for example, select the carrier frequency (such as by consulting with ranked list) with the lowest signal strength, according to an example embodiment. Or, if the carrier frequency with the lowest signal strength is restricted to access by only certain users, or if the lowest signal strength carrier is already being used (but has an unacceptable error rate or link quality), then the home base station 108 may select the carrier frequency with a signal strength measurement indicating the next lowest level of signal interference (or next lowest received signal strength), for example.

Or in the example case of multiple nodes in a home wireless network reporting signal strength measurements, the ranked list of carrier frequencies may be ranked based on average signal strength measurements. Likewise, in such an example, to select a second carrier frequency, a carrier frequency having a lowest average signal strength or a next lowest average signal strength may be selected.

In the example of CDMA or W-CDMA carrier frequencies, the home base station 108 may thereby utilize the “soft” capacity limits of CDMA, which allow multiple users to communicate along the same carrier frequency with a linear increase in the noise floor. The home base station 108 may thereby select the carrier frequency with the lowest noise floor (or a next lowest noise floor), according to an example embodiment.

Based on the selecting the second carrier frequency, the home base station 108 may change from the first carrier frequency to the second carrier frequency by, for example, requesting the mobile node 112 (and possibly other mobile nodes 114, 116 if present) to use the new carrier frequency (408) for DL transmissions. The home base station 108 may, for example, send an instruction in the first downlink carrier frequency to the mobile node 112 to receive further data transmissions in the second downlink carrier frequency. The instruction may also include an uplink carrier frequency along which the mobile node 112 should send further data transmissions. Or, the mobile node 112 may be programmed and/or configured to send further data transmissions along an uplink carrier frequency which corresponds to the second downlink carrier frequency based on changing to the second downlink carrier frequency. Or, the mobile node 112 may continue to send data transmissions along the uplink carrier frequency selected by the home base station 108 during the auto-setup method 202 described with reference to FIG. 2.

While the downlink carrier frequency selection has been described with reference to selecting one downlink carrier frequency, more than one uplink or downlink carrier frequency may be selected and used for data transmission. The data transmissions may be made with or without cell sectorization.

FIG. 5 is a flowchart showing an ongoing mobile node call method 206 corresponding to the ongoing mobile node call phase (206) shown in FIG. 2. According to an example embodiment of this method 206, in which one or more mobile nodes 112 are already in the home wireless network 102, the home base station 108 may request the mobile nodes 112, 114, 116 to send signal strength measurements for the available carrier frequencies to the home base station 108 (502). The request may be sent along the downlink carrier frequency selected as described with reference to FIG. 4. According to an alternative example embodiment, the mobile node(s) 112, 114, 116 may periodically send signal strength measurements and/or error reports to the home base station 108 with or without a request from the home base station.

The mobile nodes 112, 114, 116 may receive data transmissions, and generate and send error reports and/or signal strength measurements to the home base station 108, in a manner similar to that described with reference to FIG. 4. The home base station 108 may receive the error reports and/or signal strength measurements and determine whether there is a poor link quality on the carrier frequency (504) for a plurality of mobile nodes 112, 114, 116 or for a majority of mobile nodes, in a manner similar to that described with reference to FIG. 4. If the home base station 108 determines that the link quality on the carrier frequency is poor (e.g., a majority, or a threshold percentage or more of reporting nodes indicate an error rate higher than a threshold, or an average link quality for the reporting nodes for the carrier frequency is below a threshold), the base station may change the carrier frequency (506) in a manner similar to that described with reference to FIG. 4. Based on changing the carrier frequency, the home base station 108 may request that the mobile nodes 112, 114, 116 to use the new carrier frequency (508), and send and receive transmissions along the new selected downlink carrier frequency and uplink carrier frequency, in a manner similar to that described with reference to FIG. 4.

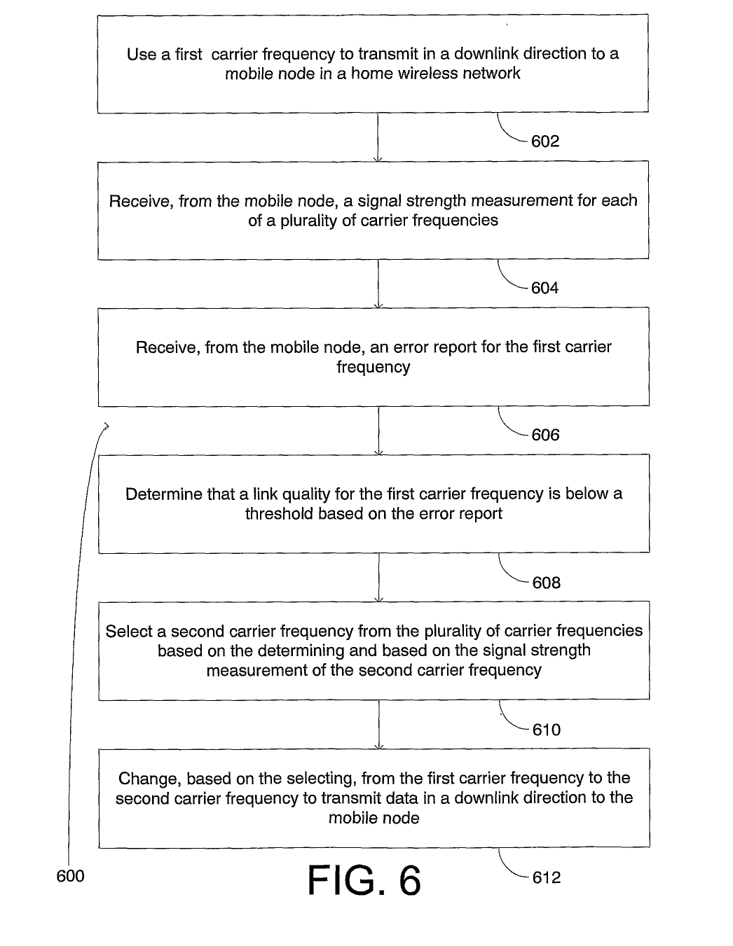

FIG. 6 is a flowchart showing a method 600 according to an example embodiment. According to this example, the method 600 may include using a first CDMA (code division multiple access) carrier frequency to transmit in a downlink direction to a mobile node 112 in a home wireless network 102 (602). The home wireless network 102 may have an area of coverage extending less than one hundred meters from the home base station 108. Using the first CDMA carrier frequency may comprise using a first wideband CDMA (W-CDMA) carrier frequency to transmit data in the downlink direction to the mobile node 112 in the home wireless network 102, according to an example embodiment. According to another example embodiment, using the first CDMA carrier frequency may comprise selecting the first CDMA carrier frequency, receiving a registration request from the mobile node 112, and using the first CDMA carrier frequency to transmit data in a downlink direction to the mobile node 112 in the home wireless network 102.

The method 600 may further comprise receiving, from the mobile node 112, a signal strength measurement for each of a plurality of CDMA carrier frequencies (604). According to an example embodiment, the receiving the signal strength measurement may include receiving, from the mobile node 112, the signal strength measurement for each of the plurality of CDMA carrier frequencies, the plurality of CDMA carrier frequencies being shared by both the home wireless network 102 and an overlay wireless network 100, the overlay wireless network 100 having an area of coverage that is greater than and overlaps an area of coverage of the home wireless network 102. According to another example embodiment, the receiving the signal strength measurement may include receiving, from the mobile node 112, a received signal strength indication (RSSI) report for each of the plurality of CDMA carrier frequencies measured during a data transmission gap interval.

The method 600 may also include receiving, from the mobile node 112, an error report for the first carrier frequency (606). Receiving the error report may include receiving, from the mobile node 112, an error report for the first carrier frequency indicating an error rate, or number or rate of negative acknowledgments (NACKs) detected by the mobile node for the first CDMA carrier frequency, according to an example embodiment. According to another example embodiment, the receiving the error report may include receiving a plurality of NACKs from the mobile node 112. According to yet another example embodiment, the receiving the error report may include receiving a block error report from the mobile node 112.

The method 600 may further include determining that a link quality for the first CDMA carrier frequency is below a threshold based on the error report (608). The method 600 may further include selecting a second CDMA carrier frequency from the plurality of CDMA frequencies based on the determining and based on the signal strength measurement of the second CDMA carrier frequency (610). The method 600 may also include changing, based on the selecting, from the first CDMA carrier frequency to the second COMA carrier frequency to transmit data in a downlink direction to the mobile node 112 (612).

According to an example embodiment, the method 600 may further include compiling, based on the signal strength measurements, a ranked list including one or more of the plurality of CDMA carrier frequencies. In this example, the selecting the second CDMA carrier frequency may include selecting the second CDMA carrier frequency based on the ranked list, the second CDMA carrier frequency having a signal strength measurement indicating a next lowest level of signal interference.

According to another example embodiment, the CDMA carrier frequencies may be shared between the home wireless network 102 and an overlay network 100. According to yet another example embodiment, the method 600 may further include notifying the mobile node 112 of the second CDMA carrier frequency to be used for downlink transmission.

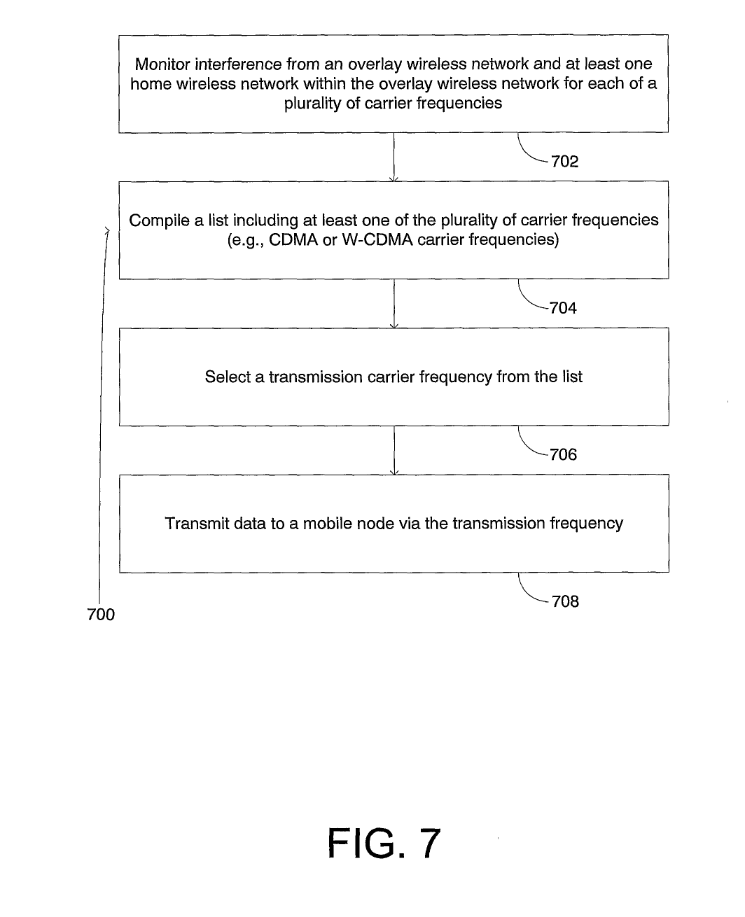

FIG. 7 shows a method 700 according to another example embodiment. According to this example, the method 700 may include monitoring interference from other sources, such as from, for example, an overlay wireless network 100 and/or neighboring home wireless networks, for each of a plurality of carrier frequencies (702). The carrier frequencies may be CDMA or W-CDMA carrier frequencies, for example, although the disclosure is not limited thereto. The monitoring may include receiving a signal strength measurement for each of the plurality of CDMA carrier frequencies from a mobile node 112.

The method 700 may further include compiling a list including at least two of the plurality of CDMA carrier frequencies (704). The compiling may include ranking the at least two of the plurality of CDMA carrier frequencies according to the monitored (or measured) interference.

The method 700 may further include selecting a transmission CDMA carrier frequency from the list (706). The selecting may include selecting the transmission CDMA carrier frequency in response to receiving a request to change frequencies from a radio network controller.

The method 700 may further include transmitting data to the mobile node 112 via the transmission CDMA frequency (708). The transmitting data may include changing, based on the selecting, from a first CDMA carrier frequency to the transmission CDMA carrier frequency.

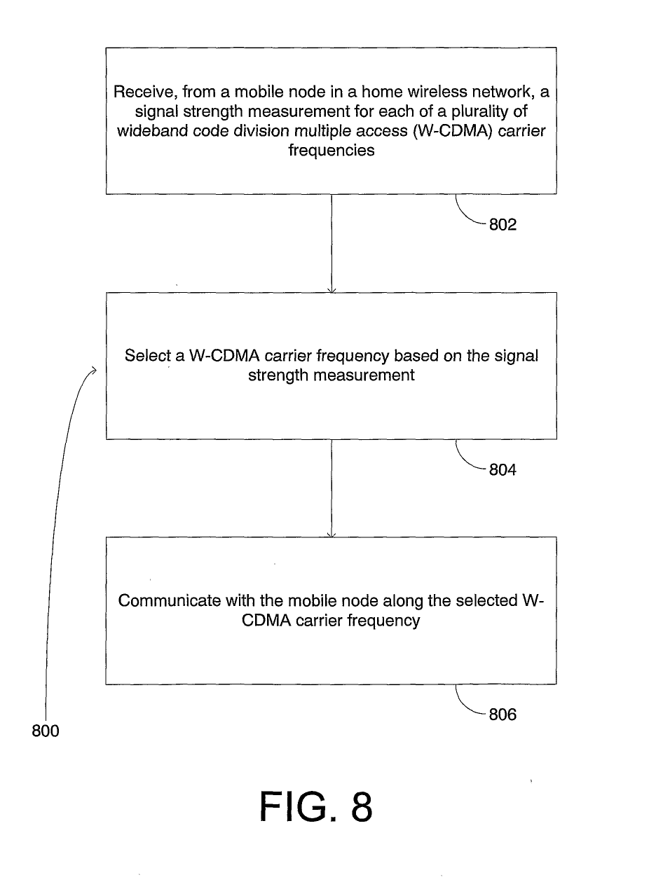

FIG. 8 shows a method 800 according to another example embodiment. According to this example, the method 800 may include receiving, from a mobile node 112 in a home wireless network 102, a signal strength measurement for each of a plurality of wideband code division multiple access (W-CDMA) carrier frequencies (802). The method 800 may further include selecting a W-CDMA carrier frequency based on the signal strength measurement (804), and communicating with the mobile node 112 along the selected W-CDMA carrier frequency (806).

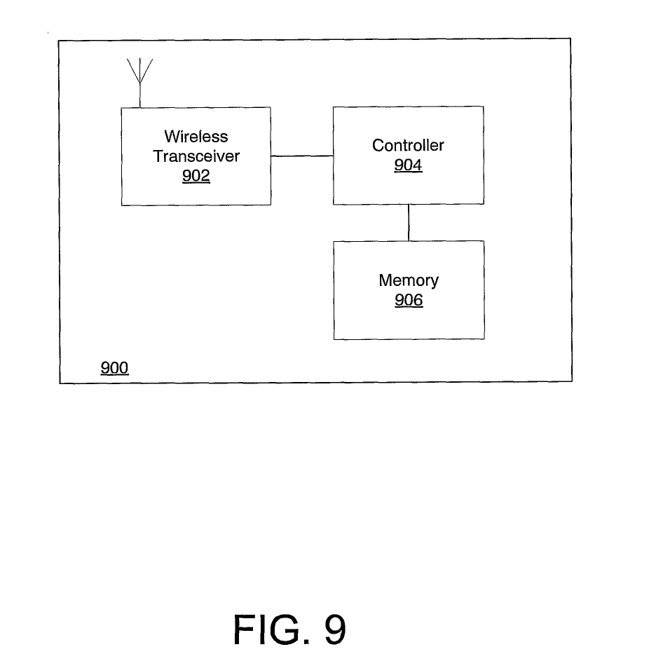

FIG. 9 is a block diagram of a wireless node 900 according to an example embodiment. The wireless node (e.g. overlay base station 106, home base station 108, 110, or mobile node 112, 114, 116, 118, 120, 122) may include, for example, a wireless transceiver 1202 to transmit and receive signals, a controller 1204 to control operation of the station and execute instructions or software, and a memory 1206 to store data and/or instructions.

Controller 904 may be programmable and capable of executing software or other instructions stored in memory or on other computer media to perform the various tasks and functions described above, such as one or more the tasks or methods described above.

In addition, a storage medium may be provided that includes stored instructions, when executed by a controller or processor that may result in the controller 904, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-27. (canceled)

28. A method comprising:
using a first carrier frequency to transmit in a downlink direction to a mobile node in a home wireless network;
receiving, from the mobile node, a signal strength measurement for each of a plurality of carrier frequencies;
receiving, from the mobile node, an error report for the first carrier frequency;
determining that a link quality for the first carrier frequency is below a threshold based on the error report;
selecting a second carrier frequency from the plurality of carrier frequencies based on the determining and based on the signal strength measurement of the second carrier frequency;
changing, based on the selecting, from the first carrier frequency to the second carrier frequency to transmit data in the downlink direction to the mobile node.

29. The method of claim 28 wherein the determining comprises determining that a link quality for the first carrier frequency is below a threshold based on a majority or more of the error reports from a plurality of mobile nodes indicating a link quality below a threshold, or based on an average link quality being below a threshold.

30. The method of claim 28 wherein the selecting comprises selecting a second carrier frequency from the plurality of carrier frequencies based on the determining and based on a ranked list of average signal strength measurements for the plurality of carrier frequencies.

31. The method of claim 28 wherein the receiving the signal strength measurement comprises receiving, from the mobile node, the signal strength measurement for each of the plurality of carrier frequencies, the plurality of carrier frequencies being shared by both the home wireless network and an overlay wireless network, the overlay wireless network having an area of coverage that is greater than and overlaps an area of coverage of the home wireless network.

32. The method of claim 28 wherein the receiving the signal strength measurement comprises receiving, from the mobile node, a received signal strength indication report for each of the plurality of carrier frequencies measured during a data transmission gap interval.

33. The method of claim 28 wherein the receiving the error report comprises receiving, from the mobile node, an error report for the first carrier frequency indicating an error rate, or number or rate of negative acknowledgments detected by the mobile node for the first carrier frequency.

34. The method of claim 28 wherein the receiving the error report comprises receiving a plurality of negative acknowledgments from the mobile node.

35. The method of claim 1 wherein receiving the error report comprises receiving a block error report from the mobile node.

36. The method of claim 28 and further comprising compiling, based on the signal strength measurements, a ranked list including one or more of the plurality of carrier frequencies;
wherein the selecting the second carrier frequency comprises selecting the second carrier frequency based on the ranked list, the second carrier frequency having a signal strength measurement indicating a next lowest level of signal interference.

37. The method of claim 28 and further comprising compiling, based on the signal strength measurements, a list including one or more of the plurality of carrier frequencies;
wherein the selecting the second carrier frequency comprises selecting the second carrier frequency based on the list, the carrier frequency having a measured signal strength indicating a lowest level of signal interference.

38. The method of claim 28 wherein the using comprises:
selecting the first carrier frequency;
receiving a registration request from the mobile node; and
using the first carrier frequency to transmit data in a downlink direction to the mobile node in the home wireless network.

39. The method of claim 28 and further comprising notifying the mobile node of the second carrier frequency to be used for downlink transmission.

40. An apparatus comprising:
at least one processor
and at least one memory including computer program code,
the at least one memory and the computer program code configured to, with the at least one processor, cause the apparatus at least to
use a first carrier frequency to transmit in a downlink direction to a mobile node in a home wireless network;
receive, from the mobile node, a signal strength measurement for each of a plurality of carrier frequencies;
receive, from the mobile node, an error report for the first carrier frequency;
determine that a link quality for the first carrier frequency is below a threshold based on the error report;
select a second carrier frequency from the plurality of carrier frequencies based on the determined link quality and based on the signal strength measurement of the second carrier frequency; and
change, based on the selection, from the first carrier frequency to the second carrier frequency to transmit data in the downlink direction to the mobile node.

41. A computer program product comprising a computer-readable medium bearing computer program code embodied therein for use with a computer, the computer program code comprising:
code for
using a first carrier frequency to transmit in a downlink direction to a mobile node in a home wireless network;
receiving, from the mobile node, a signal strength measurement for each of a plurality of carrier frequencies;
receiving, from the mobile node, an error report for the first carrier frequency;
determining that a link quality for the first carrier frequency is below a threshold based on the error report;
selecting a second carrier frequency from the plurality of carrier frequencies based on the determined link quality and based on the signal strength measurement of the second carrier frequency; and
changing, based on the selection, from the first carrier frequency to the second carrier frequency to transmit data in the downlink direction to the mobile node.
